(19) United States
(12) Patent Application Publication
(10) Pub. No.: US 2009/0254799 A1
(43) Pub. Date: Oct. 8, 2009

(54) SYSTEM FOR CREATING GRAPHICAL DISPLAY FROM TEXT

(76) Inventor: Michael Unger, Miami Beach, FL (US)

Correspondence Address: ROBERT M. SCHWARTZ, P.A., P.O. BOX 221470, HOLLYWOOD, FL, 33022, US

(21) Appl. No.: 12/418,650

(22) Filed: Apr. 6, 2009

Related U.S. Application Data
(60) Provisional application No. 61/042,351, filed on Apr. 4, 2008.

(51) Int. Cl. G06F 17/00; G06F 17/30; G06F 15/16

(52) U.S. Cl. 715/204; 707/3; 709/206; 715/863; 715/773; 707/E17.108

(57) ABSTRACT

A graphical creation software system implemented on a computer comprising a program embodied on a computer-readable medium, the system being for use by a user to create a graphical presentation of text input into the system having, a screen display, a library of graphical images, a computer-based interface to correlate images from said library with text input by a user; and an output mechanism for displaying the graphics correlated with text input.

### INDEX TO RELATED APPLICATIONS

This application claims benefit of U.S. Provisional Application No. 61/042,351 filed Apr. 4, 2008, the disclosure of which is incorporated herein by reference in its entirety.

### BACKGROUND OF THE INVENTION

Graphical representation of text represents the earliest form of writing. Today, computers assist in graphical representations of communications. However, one area that has still not been available is the automatic generation of graphical images based on the text provided by a user.

The present invention addresses this area.

### BRIEF SUMMARY OF THE INVENTION

The present invention provides a system that takes text input by the user and creates a graphical representation of the text.

In one embodiment, the system of the invention is carried out by accessing an Internet web site and following the steps of:
1. Register an email and/or a cell phone number;
2. logging in after registration;
3. click on a Create Message icon;
4. a box next to “Learning Mode” is selected before selecting “PREVIEW”;
5. Text is entered in a appropriate field and PREVIEW is selected;
6. a computer implemented system queries a database of images correlated with words.
7. the text input is correlated and an output is produced.

The text is converted into pictures and graphics based on images and graphics in the database of images.

Each word is represented by an image or a combination of images. In one embodiment, a ‘minus or ‘plus’ sign appears by a word indicating a need to add or subtract letters in order to form a word correlated with the image database. A user can discard undesired images and initiate an additional query and output.

When a user accepts the graphical output, the output may be forwarded electronically by email, text message, SMS, or any other acceptable method.

The system further allows a user to add images to the database and correlate the images with specific words. Images are uploaded to either or both of a general image database or to an image database restricted to a particular user.

### BRIEF DESCRIPTION OF THE DRAWINGS

FIG. 1 is a screen shot showing input of text.

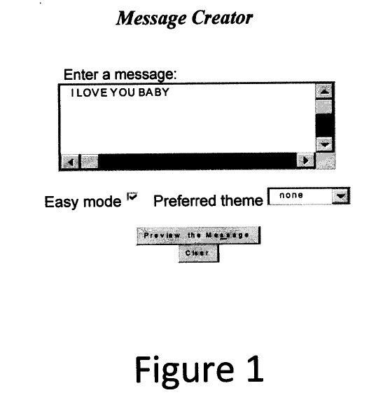

FIG. 2 is a screen shot showing graphical output from test of FIG. 1.

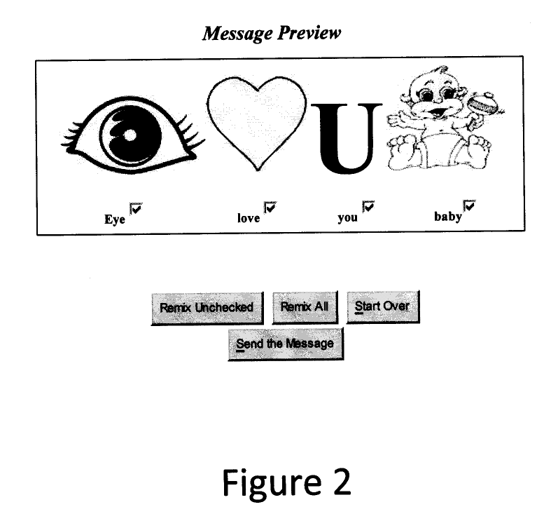

### DETAILED DESCRIPTION OF THE PREFERRED EMBODIMENTS

The present invention provides a system and method that creates graphical images from text input by user. The text may be input by any means. Input may include but would not be limited to typed text, spoken words converted to text, text input from a document that was cut and pasted into the text input area of the system.

The system further provides for a computer-based interface by which the text is correlated with a library of graphical images. Graphical images may include any graphical representation of a word including publicly available graphics, copyrighted graphics that are used with permission of the copyright owner, and may be photographs, drawings, or any other graphical representation that may be correlated with a word.

The system further comprises an option by which a user may select from various graphical images associated with a single word. In order to keep the system from becoming overly burdensome, the system is provided with a mechanism by which a user can reach direct the amount of graphics presented for each single word. For example, a user can configure the system to return no more than three graphical images for a single word, and the user may then select from the present to graphical images to create the final graphical representation of the presented text.

Additionally, the system provides a feature by which if a user does not want to use any of the graphical representations presented for a given word, an Internet query is undertaken to find a graphical image the user desires to employ. Alternatively, the system provides an option for a user to upload an image to be used either in a specific application, or for the image to be correlated with a particular word or phrase.

The output of the graphical image in the system of the present invention may be any computer-generated output. The output may include but would not be limited to a video display, including a display on a computer, cellular telephone, or personal digital assistant, or a printed display.

The system may further include the ability for a user to view and output graphical image and select a single image for revision.

Additionally contemplated in the system of the present invention would be the ability to electronically send the graphical representation output by the system to a recipient. The recipient may receive the graphical representation by e-mail, text message, SMS, a URL that would access a stored graphical representation, and combinations thereof.

The system of the present invention further encompasses a mechanism by which a user selectively rejects one or more graphical images and the system will provide alternative images which then may be selected by a user. The alternative images are presented as single image or as a group of possible replacement images.

It is impossible to have a picture that is representative of Lo every single word in the English language. The present invention encompasses an algorithm to look for partial words contained within the subject word, for which the system has a picture or pictures to represent it. In addition, many words can be represented by overlaying an image of a contained word with a plus(+) letter(s) and or a minus(−) letter(s), to complete the desired word.

### EXAMPLE 1

### Baseball

If the system does not have an actual image, the algorithm will find the words ‘BASE’ and ‘BALL’ and use the images representing BASE+BALL to create the translation in the message.

### EXAMPLE 2

### Chat

It is difficult to represent the idea of CHAT in a picture. The system uses an image of a HAT and the letter ‘C+’ overlayed on the image.

While the invention has been described in its preferred form or embodiment with some degree of particularity, it is understood that this description has been given only by way of example and that numerous changes in the details of construction, fabrication, and use, including the combination and arrangement LO of parts, may be made without departing from the spirit and scope of the invention.

I claim:

1. A graphical creation software system implemented on a computer comprising a program embodied on a computer-readable medium, the system being for use by a user to create a graphical presentation of text input into the system the system providing:
(a) a screen display, permitting user-operable input of text;
(b) a library of graphical images;
(c) a computer-based interface to correlate images from said library with text input by a user; and
(d) an output mechanism for displaying the graphics correlated with text input.

2. The system of claim 1 wherein the input of text is through a touch screen, keyboard, or voice recognition software to create text.

3. The system of claim 1 wherein the library of graphical images comprises an Internet query to locate images and add selected images to said library of graphical images.

4. The system of claim 1 wherein the library of graphical images comprises an Internet query to locate images and add selected images to a personal library of graphical images.

5. The system of claim 1 wherein the correlation of images is restricted to a specific number of acceptable images.

6. The system of claim 1 wherein the output is a video display, printer, or both.

7. The system of claim 1 further comprising an ability to send the output graphical representation electronically.

8. The system of claim 1 further comprising the ability to send the output graphical representation electronically in an e-mail, text message, or URL that accesses the saved graphical representation.
